(19) United States
(12) Patent Application Publication
(10) Pub. No.: US 2005/0180013 A1
(43) Pub. Date: Aug. 18, 2005

(54) Grating element for filtering wavelengths < 100 nm

(75) Inventors: Klaus Heidemann, Oberkochen (DE); Karlfrid Osterried, Aalen (DE)

Correspondence Address: CHARLES N.J. RUGGIERO, ESQ.;OHLANDT, GREELEY, RUGGIERO & PERLE, L.L.P., ONE LANDMARK SQUARE, 10th FLOOR, STAMFORD, CT, 06901-2682, US

(73) Assignee: Carl Zeiss SMT AG

(21) Appl. No.: 10/945,626

(22) Filed: Sep. 21, 2004

Related U.S. Application Data
(63) Continuation of application No. PCT/EP03/02419, filed on Mar. 10, 2003.

(30) Foreign Application Priority Data
Mar. 21, 2002 (DE) 102 12 691.7

(51) Int. Cl. G01J 3/18

(52) U.S. Cl. 359/566

(57) ABSTRACT

There is provided a grating apparatus for filtering wavelengths ≦100 nm. The grating apparatus includes multiple individual grating elements having grating lines. The individual grating elements are positioned one behind another on a curved support surface in relation to a plane spanned by the grating apparatus in a direction of beans of a light bundle that is incident on the grating apparatus.

### CROSS-REFERENCE TO RELATED APPLICATIONS

The present application is a continuation of International Application No. PCT/EP03/02419, filed Mar. 10, 2003, which claims priority of German Patent Application No. 102 12 691.7, filed Mar. 21, 2002. The content of these applications is herein incorporated by reference.

### BACKGROUND OF THE INVENTION

1. Field of the Invention

The present invention relates to a grating element for filtering wavelengths ≦100 nm, having multiple individual grating elements, the individual grating elements having grating lines resulting in a grating periodicity.

2. Description of the Related Art

In order to be able to reduce the structure widths for electronic components even further, particularly in the submicron range, it is necessary to reduce the wavelength of the light used for microlithography. The use of light having wavelengths less than 100 nm, e. g., lithography using soft x-rays, i.e., EUV lithography, for example, is conceivable.

EUV lithography is one of the most promising future lithography technologies. Currently, wavelengths in the range of 11-14 nm, particularly 13.5 nm, are under discussion as the wavelengths for EUV lithography for a numeric aperture of 0.2-0.3. The image quality in EUV lithography is determined by the projection objective and by the illumination system. The illumination system is to provide the most uniform possible illumination of the field plane in which the structure-bearing mask, the reticle, is positioned. The projection objective images the field plane in an image plane, i.e., the wafer plane, in which a light-sensitive object is positioned. Projection exposure systems for EUV lithography are implemented using reflective optical elements. The shape of the field of an EUV projection exposure system is typically that of an annular field having a high aspect ratio of 2 mm (width)×22-26 mm (curve length). The projection systems are typically operated in scanning mode. Reference is made to the following publications in regard to EUV projection exposure systems:
W. Ulrich, S. Beiersdörfer, H. J. Mann, “Trends in Optical Design of Projection Lenses for UV and EUV lithography” in Soft X-ray and EUV Imaging Systems, W. M. Kaiser, R. H. Stulen (Editors), Proceedings of SPIE, Volume 4146 (2000), pp. 13-24, and
M. Antoni, W. Singer, J. Schultz, J. Wangler, I. Escudero-Sanz, B. Kruizinga, “Illumination Optics Design for EUV Lithography” in Soft X-ray and EUV Imaging Systems, W. M. Kaiser, R. H. Stulen (Editors), Proceedings of SPIE, Volume 4146 (2000), pp. 25-34.

The content of each of these publications is included in its entirety in the present application.

In illumination systems for wavelengths ≦100 nm, the problem exists that the light sources of illumination systems of this type emit radiation which may lead to undesired exposure of the light-sensitive object in the wafer plane of the projection exposure system and, in addition, optical components of the exposure systems, such as the multilayer mirror, are heated in this way.

To filter out the undesired radiation, transmission filters, made of zircon, for example, are used in illumination systems for wavelengths ≦100 nm. Filters of this type have the disadvantage of high light losses. Furthermore, they may be destroyed very easily through thermal stress.

As an alternative to this, it is possible to perform the filtering using grating elements, which have multiple individual gratings having a grating period assigned to the individual gratings, for example. In a method of this type, use is made of the circumstance that light of the 0^{th} order of diffraction in particular, which corresponds to a significant component of radiation having wavelengths which are not of the used wavelengths, in the range of 7 to 25 nm, for example, may be filtered out with the help of a diaphragm down stream of the grating element in the beam path.

Grating elements, such as reflection gratings, particularly echelette gratings having a total efficiency near 60%, have been known for sometime from monochromator construction for synchrotron radiation sources. Good results are obtained using gratings in a monochromator construction even when the monochromator is illuminated by a synchrotron radiation source having a high energy flux.

The behavior at diffraction gratings is described by the grating equation
n(λ/p)=sin α−sin β
using the grating period p, the order of diffraction n, the angle of incidence in relation to the surface normal α, the angle of diffraction in relation to the surface normal β, and the wavelength λ.

If one observes convergent or divergent radiation, the optical effect of the grating must be considered.

Reference is made to the following publications, the content of whose disclosure is included in its entirety in the present application, in regard to the use of diffraction gratings in monochromators:
H. Petersen, C. Jung, C. Hellwig, W. B. Peatman, W. Gudat: “Review of plane grating focusing for soft x-ray monochromators”, Rev. Sci. Instrum. 66 (1), January 1995
M. V. R. K. Murty: “Use of convergent and divergent illumination with plane gratings”, Journal of the Optical Society of America, Volume 52, No. 7, July 1962, pp. 768-773
T. Oshio, E. Ishiguro, R. Iwanaga: “A theory of new astigmatism- and coma-free spectrometer”, Nuclear Instruments and Methods 208 (1993) 297-301

A grating element may be used for spectral filtering in an illumination system for wavelengths ≦100 nm if the individual orders of diffraction and the wavelengths are clearly separated from one another.

This is simplest in a focused beam. In this case, a focus or light source image having a defined diameter exists in the focal point. However, a certain aperture must be selected for the focused beam so that overall lengths which are too long do not result. For beam bundles at higher aperture, however, the grating design is more difficult, or greater aberrations are obtained.

If the requirement of separating the individual orders of diffraction is fulfilled, complicatedly constructed grating elements result, having a continuously changing grating constant or an arrangement on a curved surface, for example. Gratings of this type may only be manufactured with a very large effort.

Alternatively, the grating element may also be constructed from multiple individual gratings having continuously changing grating constants.

The individual gratings are preferably designed as blaze gratings, which are optimized for maximum efficiency in one order of diffraction. Blaze gratings are known, for example, from Lexikon der Optik [Lexicon of Optics], edited by Heinz Hagerborn, pp. 48-49. They are distinguished by an approximately triangular groove profile.

A grating element which is constructed from multiple individual gratings has the disadvantage that if the same blaze angle is used for the different individual gratings in the convergent beam path, because of the angular divergence of the incident beams, a strongly varying diffraction efficiency results in the 1st order, for example; i.e., η (1), depending on the point of incidence. If the gratings are implemented with different blaze depths depending on the position, the blaze depth differences of the different individual gratings are very large, which requires very complex manufacturing.

### SUMMARY OF THE INVENTION

The object of the present invention is thus to overcome the disadvantages of the related art, in particular to specify a grating apparatus that is easy to manufacture, separates the 0^{th} and 1^{st} orders of diffraction, and provides a grating apparatus, even in the convergent beam path, that has a largely uniform diffraction efficiency independently of the angle of incidence of the beams of the beam bundle, so that if a grating apparatus of this type is used in an illumination system, a largely homogeneous intensity distribution is implemented behind a diaphragm plane.

The above-mentioned object is achieved in that the individual grating elements are positioned one behind another, in the direction of the beams of the beam bundle which is incident on the grating apparatus, on a curved surface in relation to the plane spanned by the grating apparatus. The curved surface is generally a surface having continuous curvature, the curvature of the surface not being spherical, but rather increasing with a decreasing angle of incidence.

In a preferred embodiment, the curved support surface is a curved surface approximated by a continuous polygonal progression. This has the advantage that flat individual gratings may be used, which are easier to manufacture.

The individual gratings positioned one behind another on a curved surface preferably each have variable grating periods. In this way, even better separation of the 0th and 1st orders of diffraction is achieved. If an average line density G of the individual grating elements is defined, the line density on the individual gratings varies by Δg and Δg is in the range 40 lines/mm≦Δg≦200 lines/mm.

It is preferable if the individual grating elements, as described previously, for individual grating elements positioned on a continuous polygonal progression, each have a flat grating surface comprising the grating lines.

As an alternative to this, the individual grating elements may each have an aspheric grating surface, comprising the grating lines, by which the required variation of the line density may be reduced.

In order to prevent astigmatic fading of the intermediate image, which is generally caused by the diffraction of the convergent beam bundle on planar gratings, the grating lines of an individual grating element may be curved.

The curvature of the support surface on which the individual grating elements are positioned is preferably selected so that the blaze angle of the individual grating elements implemented as blaze gratings varies so little that the diffraction efficiency deviates only slightly from the maximum blaze efficiency.

In addition to the grating apparatus according to the present invention, the present invention also provides an illumination system having such a grating apparatus. The illumination system comprises an object plane and a field plane, at least one grating apparatus according to the present invention, and at least one physical diaphragm in a diaphragm plane, which is positioned downstream from the grating apparatus in the beam path from the object plane to the field plane.

In an illumination system having two faceted optical elements, as is disclosed, for example, in U.S. Pat. No. 6,198,793 or U.S. Pat. No. 6,438,199, the content of whose disclosure is included in its entirety in the present application, a largely homogeneous intensity distribution, i.e., homogeneous illumination, is achieved particularly in the plane in which the mirror with field facets is positioned downstream of the physical diaphragm in the beam path.

The at least one physical diaphragm in the illumination system is used for the purpose of avoiding stray light of other than the desired order of diffraction, particularly the 0^{th} order of diffraction, having wavelengths well above 100 nm, reaching the illumination system. The at least one physical diaphragm preferably blocks the light of the 0^{th} order of diffraction and the further orders of diffraction except for the desired order of diffraction, which is preferably the 1^{st} order of diffraction. It is especially preferable if the beams have wavelengths in the range from 7 to 25 nm after the physical diaphragm due to the combination of grating and physical diaphragm.

To generate a convergent light bundle, the illumination system may comprise a collector unit. The collector unit provides for the convergent light bundle, and when the convergent light bundle impinges onto the grating apparatus, the convergent light bundle is deflected.

The focus of the light bundle for an n^{th} order of diffraction of the grating apparatus especially preferably comes to lie at the location of the physical diaphragm or in proximity to the physical diaphragm, wherein |n|=1.

In order to avoid too large of a thermal load on the physical diaphragm in the diaphragm plane or on following optical elements, a part of the undesired radiation may be filtered out through further diaphragms in the illumination system.

### BRIEF DESCRIPTION OF THE DRAWINGS

The present invention will be described in the following for exemplary purposes on the basis of the drawings:

FIG. 1 shows an arrangement of a grating apparatus having individual gratings positioned one behind another in the beam path from the collector unit of an illumination system to a diaphragm

FIG. 2 shows an exemplary embodiment of the present invention having 18 individual grating elements

FIG. 3 shows a schematic sketch for deriving the characteristic values of the exemplary embodiment according to FIG. 2

FIGS. 4a and 4b show an illustration of a blaze grating for deriving the blaze depths and/or the blaze angle

FIG. 5 shows the diffraction efficiency for grating elements, implemented as blazed gratings, which are made of different materials

FIG. 6 shows an EUV projection exposure system having an illumination system according to the present invention.

### DESCRIPTION OF THE INVENTION

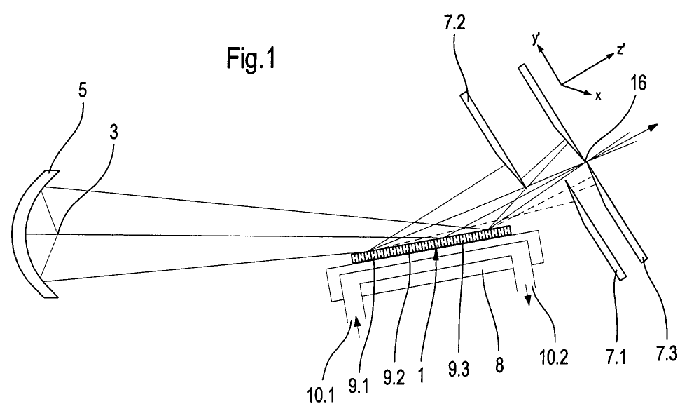

FIG. 1 shows a grating apparatus 1 having multiple individual gratings 9.1, 9.2, 9.3 in the beam path of an illumination system. The individual gratings 9.1, 9.2, 9.3 are positioned one behind another in the beam direction. The light of a light source 3 is collected by a collector unit, e.g., collector 5. In this example, the collector 5 is an ellipsoidal mirror which generates an image of the light source 3. The collimated light bundle having an aperture of approximately NA=0.1 downstream of the collector 5 is deflected via the grating apparatus 1 in grazing incidence in such a way that the intermediate image of the light source generated by the grating through diffraction in the +1^{st} order of diffraction comes to lie at a focus 16 in or near the diaphragm plane of a physical diaphragm 7.3.

Undesired radiation may already be filtered out by multiple partial diaphragms 7.1, 7.2 positioned in front of the physical diaphragm 7.3, in order to reduce the thermal load on the physical diaphragm 7.3 having the circular opening, which is located in the focal plane of the desired order of diffraction, in this case the +1^{st} order 16. The partial diaphragms 7.1, 7.2 may additionally be cooled, which is not shown. The grating apparatus 1 may also be cooled, through a rear cooler, for example a rear cooling device 8. The rear cooling device 8 is preferably a liquid cooling device having inlet and outlet 10.1, 10.2. Through the grating apparatus 1 and the physical screen 7.3, it is possible to completely block the 0^{th} order, which comprises all wavelengths of the light source, in an illumination system that comprises an optical element according to the present invention and a diaphragm 7.3 positioned downstream therefrom. In addition, all higher orders except the +1^{st} order are blocked.

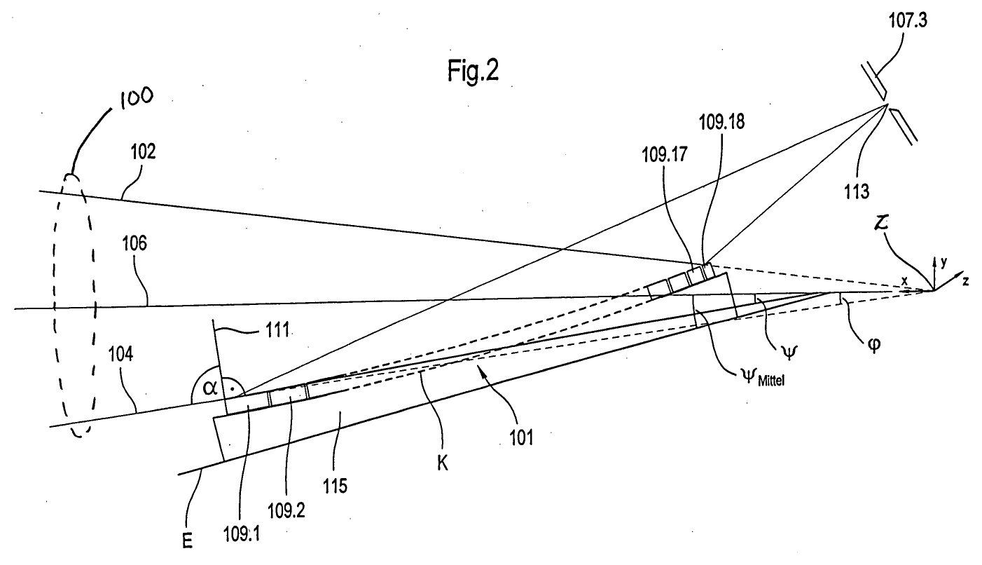

In the following, an exemplary embodiment of a grating apparatus according to the present invention having multiple individual gratings which are positioned on a curved support surface is to be specified. Identical components as in FIG. 1 are provided with a reference number increased by 100. A collimated light bundle 100 is shown, which originates from the light source (not shown in FIG. 2) and impinges onto the entire grating apparatus according to the present invention. The two edge beams 102, 104 and the center beam 106 are shown. Furthermore, the virtual intermediate image focus Z of the light source (not shown in FIG. 2), which is generated by the collector (also not shown), is shown. The origin of a rectangular coordinate system in the x, y, and z directions is defined in the intermediate image focus Z. This coordinate system is shown in FIG. 2. All values specified in the following Table 1 are based thereon. Overall, the exemplary embodiment shown in FIG. 2 comprises 18 individual grating elements. Exemplary embodiments having fewer than 18 individual gratings are also possible, having 10, 7, or 5 individual gratings, for example, without deviating from the idea of the present invention. The position of the individual grating elements, of which the individual grating elements 109.1, 109.2, 109.17, 109.18 are shown in FIG. 2, are specified in the following Table 1 in the intermediate image focus Z in the 0^{th} order of diffraction in the x and y directions in relation to the coordinate system.

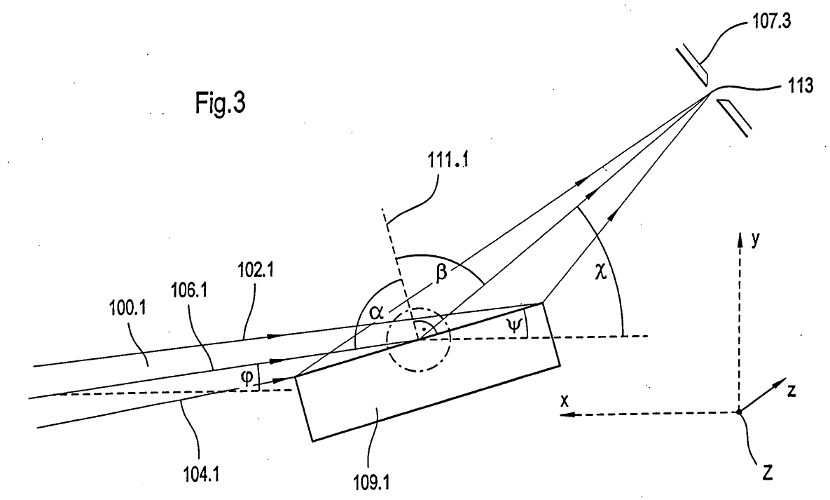

The center beam 106 of the light bundle 100 is coincident with the coordinate axis in the x direction for y=0 of the coordinate system in the intermediate image focus Z. Furthermore, a normal 111 is shown in FIG. 2, and the angles α, φ, and ω for the first individual grating element 109.1, which are shown again in greater detail in FIG. 3, are also indicated in FIG. 2. Identical components as in FIG. 2 have the same reference numbers. Each individual grating element absorbs a partial light bundle 100.1 of the total light bundle 100 originating from the light source. Each partial light bundle comprises a lower edge beam 104.1 and an upper edge beam 102.1 and a center beam 106.1. α identifies the angle of incidence of a beam, in this case the center beam 106.1 of the incident partial light bundle 100.1 in relation to the normal 111.1 of the individual grating elements 109.1, which is perpendicular to the grating surface, β identifies the angle of emergence in the order of diffraction, in this case the +1^{st} order of diffraction, of a diffracted beam, in this case the diffracted center beam 106.1 of the partial light bundle 100.1 in relation to the normal 111.1. An intermediate image of the light bundle diffracted in the +1^{st} order of diffraction comes to lie at a focus 113 in a plane of a physical diaphragm 107.3. The origin of the x, y, z coordinate system is defined as described in FIG. 2 by the virtual intermediate image focus Z.

The angle φ identifies the angle of an incident beam, such as the center beam 106.1 of the partial light bundle in relation to the coordinate axis in the x direction at y=0. The angle ω identifies the angle of inclination of the individual grating element, in this case the individual grating element 109.1, in relation to the x coordinate axis at y=0. The angle χ identifies the angle of emergence of a diffracted beam of the partial light bundle, in this case the center beam 106.1. The following interrelationships apply:
α=90°−ω−φ and
β=90°−χ+ω

The angles α, φ, and ω thus defined are specified for all individual grating elements of the entire grating apparatus composed thereof in Table 1. The angles α and φ are each specified for the lower and upper edge beams and the center beam of a partial light bundle incident on the particular individual grating element, and the angle ω identifies the angle of inclination of the particular individual grating in relation to the x-axis of the coordinate system specified by the virtual intermediate image focus.

The individual gratings, as may be seen from FIG. 3, are positioned on a continuous polygonal progression, i.e., the edges of neighboring individual gratings directly adjoin one another, so that with grazing incidence of the light bundle 100, mutual shadowing of the partial light bundles is not possible. The abutment of the edges of neighboring individual gratings is shown for the individual gratings 109.1 and 109.2. Besides the position coordinates x and y and the angle coordinates φ, α, and ω, the blaze angle ε and the grating line density G and line/mm are specified for the exemplary embodiment in Table 1 having 18 individual gratings.

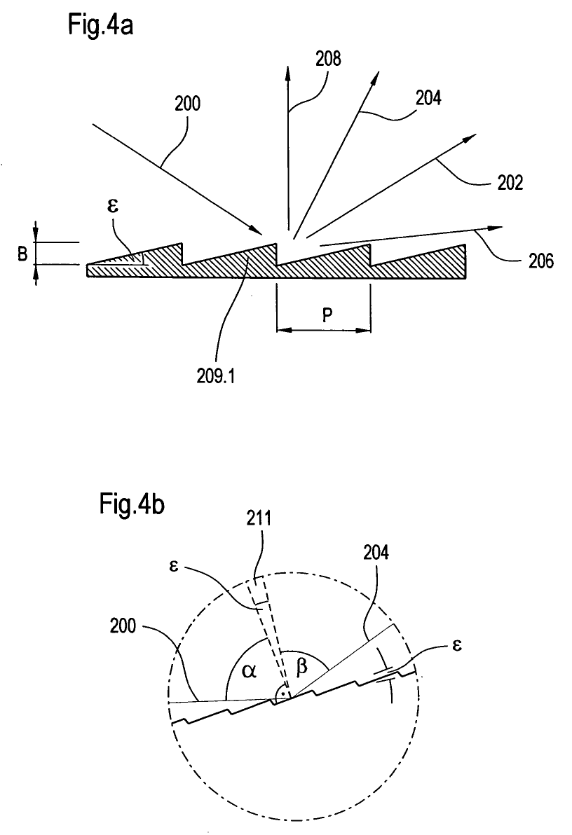

The blaze angle is defined in FIGS. 4a and 4b.

Furthermore, the physical diaphragm 107.3 downstream from the individual grating element 109.1 is shown in FIG. 3. The focus 113 of the light source (not shown in FIG. 3) generated by the +1^{st} order of diffraction of the individual grating elements 109.1, 109.2, 109.17, 109.18 lies in the plane of the physical diaphragm 107.3.

The width of the 18 individual gratings positioned on a support 115 is reduced with falling angle of incidence a from 51.25 mm for the 1^{st} individual grating 109.1 to 18.03 mm for the 18^{th} individual grating 109.18. The support 115 may be cooled. The support 115 spans a plane E which is tilted at an angle ω_{Center} in relation to the x coordinate axis. The individual grating elements are positioned on a curved surface K of the support 115 in relation to this plane E. The individual grating elements are tilted by an angle ω′=ω_{Center}−ω in relation to the plane E. The curved support surface is a continuous polygonal progression without restriction in this case. For the exemplary embodiment shown in FIG. 3, the position coordinates x, y and the angles φ, α, the blaze angle ε, and the grating constant G are specified in Table 1 in the respective columns. Furthermore, the angle of inclination ω of the particular individual grating element is specified. Since the individual grating elements are planar in the exemplary embodiment shown, it is only necessary to specify an angle of inclination ω to characterize the position of the individual grating element on the curved support surface. The position coordinates x, y and the angles φ, α, the blaze angle ε, and the grating constant G are specified for three points of an individual grating in each case, specifically the two edge points of the individual grating in the x direction and the central position of the particular individual grating in the x direction. The edge points correspond to the points of incidence of the edge beams of the particular partial light bundle and the center position corresponds to the point of incidence of the center beam of the particular light bundle. The position of the intermediate image in the −1^{st} order of diffraction is at x=54.604 mm and at y=208.885 mm in the y direction.

TABLE 1
Grating element having individual gratings positioned on a
continuous polygonal progression

| | | | | | |
|---|---|---|---|---|---|
| X | Y | φ | α | ε | |
| [mm] | [mm] | [°] | [°] | [°] | G [L/mm] |

Individual grating 1^{ψ} = 12.70033°

| | | | | | |
|---|---|---|---|---|---|
| 834.9 | −93.01 | −6.70 | 84.00 | 1.38 | 459.13 |
| 809.9 | −92.38 | −6.51 | 83.81 | 1.42 | 488.34 |
| 784.9 | −86.74 | −6.31 | 83.61 | 1.47 | 520.39 |

Individual grating 2^{ψ} = 12.81684°

| | | | | | |
|---|---|---|---|---|---|
| 784.9 | −86.74 | −6.31 | 83.49 | 1.35 | 479.20 |
| 762.84 | −81.72 | −6.11 | 83.30 | 1.39 | 507.72 |
| 740.79 | −76.71 | −5.91 | 83.09 | 1.43 | 538.83 |

Individual grating 3^{ψ} = 12.92932°

| | | | | | |
|---|---|---|---|---|---|
| 740.79 | −76.71 | −5.91 | 82.98 | 1.32 | 496.65 |
| 719.48 | −71.82 | −5.70 | 82.77 | 1.36 | 526.91 |
| 698.18 | −66.92 | −5.48 | 82.55 | 1.41 | 556.00 |

Individual grating 4^{ψ} = 13.03754°

| | | | | | |
|---|---|---|---|---|---|
| 698.18 | −66.92 | −5.48 | 82.44 | 1.30 | 516.91 |
| 677.69 | −62.17 | −5.24 | 82.20 | 1.34 | 549.08 |
| 657.19 | −57.43 | −4.99 | 81.96 | 1.38 | 584.30 |

Individual grating 5^{ψ} = 13.14127°

| | | | | | |
|---|---|---|---|---|---|
| 657.19 | −57.43 | −4.99 | 81.85 | 1.28 | 540.40 |
| 637.54 | −52.85 | −4.74 | 81.60 | 1.32 | 574.63 |
| 617.90 | −48.26 | −4.47 | 81.32 | 1.36 | 612.17 |

Individual grating 6^{ψ} = 13.24027°

| | | | | | |
|---|---|---|---|---|---|
| 617.90 | −48.26 | −4.47 | 81.23 | 1.26 | 567.58 |
| 599.15 | −43.85 | −4.19 | 80.95 | 1.30 | 604.04 |
| 580.40 | −39.44 | −3.89 | 80.65 | 1.34 | 644.07 |

Individual grating 7^{ψ} = 13.33437°

| | | | | | |
|---|---|---|---|---|---|
| 580.40 | −39.44 | −3.89 | 80.55 | 1.25 | 598.93 |
| 562.58 | −35.21 | −3.58 | 80.25 | 1.29 | 637.79 |
| 544.75 | −30.99 | −3.26 | 79.92 | 1.33 | 680.49 |

Individual grating 8^{ψ} = 13.42343°

| | | | | | |
|---|---|---|---|---|---|
| 544.75 | −30.99 | −3.26 | 79.83 | 1.24 | 634.94 |
| 527.89 | −26.96 | −2.92 | 79.50 | 1.28 | 676.38 |
| 511.02 | −22.94 | −2.57 | 79.15 | 1.32 | 721.91 |

Individual grating 9^{ψ} = 13.50738°

| | | | | | |
|---|---|---|---|---|---|
| 511.02 | −22.94 | −2.57 | 79.06 | 1.24 | 676.13 |
| 495.12 | −19.12 | −2.21 | 78.70 | 1.28 | 720.31 |
| 479.22 | −15.30 | −1.83 | 78.32 | 1.32 | 768.83 |

Individual grating 10^{ψ} = 13.58621°

| | | | | | |
|---|---|---|---|---|---|
| 479.22 | −15.30 | −1.83 | 78.24 | 1.24 | 722.99 |
| 464.29 | −11.69 | −1.44 | 77.86 | 1.28 | 770.04 |
| 449.36 | −8.08 | −1.03 | 77.44 | 1.32 | 821.70 |

Individual grating 11^{ψ} = 13.65996°

| | | | | | |
|---|---|---|---|---|---|
| 449.36 | −8.08 | −1.03 | 77.37 | 1.25 | 775.96 |
| 435.39 | −4.69 | −.62 | 76.96 | 1.29 | 826.02 |
| 421.42 | −1.29 | −.18 | 76.52 | 1.33 | 880.91 |

Individual grating 12^{ψ} = 13.72876°

| | | | | | |
|---|---|---|---|---|---|
| 421.42 | −1.29 | −.18 | 76.44 | 1.26 | 835.43 |
| 408.39 | 1.89 | .27 | 76.01 | 1.30 | 888.61 |
| 395.36 | 5.08 | .74 | 75.54 | 1.34 | 946.81 |

Individual grating 13^{ψ} = 13.79277°

| | | | | | |
|---|---|---|---|---|---|
| 395.36 | 5.08 | .74 | 75.47 | 1.28 | 901.74 |
| 383.24 | 8.05 | 1.20 | 75.00 | 1.32 | 958.11 |
| 371.11 | 11.03 | 1.70 | 74.51 | 1.36 | 1019.67 |

Individual grating 14^{ψ} = 13.85221°

| | | | | | |
|---|---|---|---|---|---|
| 371.11 | 11.03 | 1.70 | 74.45 | 1.30 | 975.12 |
| 359.88 | 13.80 | 2.20 | 73.95 | 1.34 | 1034.71 |
| 348.60 | 16.58 | 2.72 | 73.42 | 1.38 | 1099.62 |

Individual grating 15^{ψ} = 13.90732°

| | | | | | |
|---|---|---|---|---|---|
| 348.60 | 16.58 | 2.72 | 73.37 | 1.32 | 1055.70 |
| 338.16 | 19.16 | 3.24 | 72.85 | 1.36 | 1118.51 |
| 327.72 | 21.75 | 3.80 | 72.30 | 1.40 | 1186.72 |

Individual grating 16^{ψ} = 13.9584°

| | | | | | |
|---|---|---|---|---|---|
| 327.72 | 21.75 | 3.80 | 72.24 | 1.35 | 1143.51 |
| 318.05 | 24.15 | 4.34 | 71.70 | 1.39 | 1209.48 |
| 308.38 | 26.56 | 4.92 | 71.12 | 1.43 | 1280.9 |

Individual grating 17^{ψ} = 14.00571°

| | | | | | |
|---|---|---|---|---|---|
| 308.38 | 26.56 | 4.92 | 71.07 | 1.38 | 1238.46 |
| 299.42 | 28.79 | 5.49 | 70.50 | 1.42 | 1307.50 |
| 290.46 | 31.03 | 6.097 | 69.90 | 1.45 | 1381.97 |

Individual grating 18^{ψ} = 14.04956°

| | | | | | |
|---|---|---|---|---|---|
| 290.46 | 31.03 | 6.10 | 69.85 | 1.41 | 1340.32 |
| 282.15 | 33.11 | 6.69 | 69.26 | 1.45 | 1412.31 |
| 273.85 | 35.18 | 7.32 | 68.63 | 1.48 | 1489.64 |

In a second exemplary embodiment, a grating apparatus according to the present invention comprises a total of 8 individual gratings.

The grating apparatus having 8 individual gratings extends over a total of 521.5 mm in the X direction. The 8 individual gratings are flat individual grating elements which are positioned next to one another on a continuous polygonal progression.

The angle of inclination ω of the flat grating surfaces to the X-axis increases continuously and nearly linearly from 12.4° for the first element up to 13.6° for the eighth element.

The angle of incidence a falls from 83.8° for the first element to 69.4° for the eighth element. The average blaze angle ε of each of the individual elements is constant at 1.21° and has a minimum variation of ±0.2% and a maximum variation of ±7.9% over the surface of the individual elements.

The average groove density of the individual elements rises continuously from 374 L/mm for the first element to 1160 L/mm for the eighth element, the largely linear variation of the groove density dG/dX over the surface increasing continuously from 1.1 mm⁻¹ for the first element up to 7.1 mm⁻¹.

Using a grating apparatus of this type having a total of 8 individual gratings, in combination with the collector mirror element, a punctual, spectrally decomposed image of the light source is generated in the screen surface at the wavelength λ=13.5 nm. The minimum distances of the images of the source generated in the 0th and 2nd orders of diffraction from the focal point of the 1st order of diffraction on the screen surface are >14 mm and >12 mm, respectively.

The individual grating elements are coated, for example, with a ruthenium reflection coating, which has the highest reflectivity of all known metal coatings for λ=13.5 nm. The blaze efficiency in the 1st order of diffraction calculated for this reflection coating rises continuously from 65.7% for the first element to 68.1% for the fourth element and then falls to 56.8% for the eighth element.

The special advantage of this grating apparatus having a total of 8 individual gratings is that only a small number of 8 individual grating elements is necessary, the average blaze angle on all individual elements is constant, and therefore the grating grooves of all individual elements may be produced using the same technological method (e.g., mechanical grating graduation or holographic exposure with subsequent ion beam etching), all individual elements are used in a blaze arrangement, so that the diffraction efficiency is an average of 64.9%, and the efficiency only varies by +3.2/−8.1%, so that a largely homogeneous intensity distribution is achieved over the cross-section of the light bundle passing the diaphragm, and the radiation passing the diaphragm having an opening diameter of 2 mm, for example, and used in the further illumination system, which has wavelengths between 13.0 and 14.0 nm, may be separated from the radiation emitted by the source having other wavelengths with an intensity ratio of >1000/1.

In order to obtain a grating apparatus 101 having optimal diffraction efficiency η (+1) in the +1st order, each individual grating of the grating apparatus 101 is implemented as a blaze grating.

In FIG. 4a, a blaze grating having an approximately triangular groove profile is shown. An incident beam is incident on the individual grating designed as a blaze grating, such as the individual grating 209.1 having the grating period P; 202 identifies the beam diffracted at the grating in the 0th order and 204 identifies the beam diffracted in the +1 st order, 206 identifies the beam diffracted in the −1st order, and 208 identifies the beam diffracted in the +2nd order. The following equation results for the blaze angle as a function of the values cited above:
ε=arctan(B/P)

In this case, B identifies the blaze depth and P identifies the grating period. In FIG. 4b, the condition is given by the diffraction geometry shown
ε=(α−β)/2
that the incident beam 200 incident with the angle α in relation to the grating normal is diffracted with the blaze efficiency associated with blaze angle ε at the diffraction angle β in relation to a grating normal 211 into the beam in the direction toward the focus 113 in FIG. 3. Under this blaze condition, the grating equation assumes the form:
n·λ/p=sin(α)−sin(α−2ε)=sin(θ/2+ε)−sin(θ/2−ε)
in which
θ=α+β
identifies the deflection angle between incident beam 200 and beam 204.

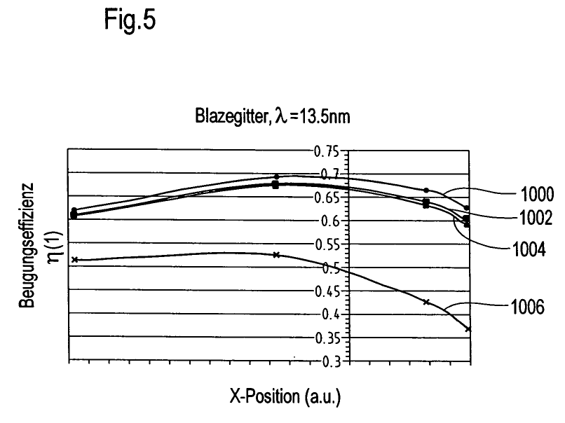

As FIG. 5 shows, the diffraction efficiency in the +1st order η (+1) is a function of the position X on the grating apparatus and on the materials used in the grating surface and/or the reflection coating applied to the grating. The x-dependence of the diffraction efficiency is determined by the x-dependence of the angle of incidence α and the blaze angle ε.

In FIG. 5, reference number 1000 identifies the diffraction efficiency η (−1) at a wavelength of λ=13.5 nm for ruthenium, reference number 1002 for palladium, reference number 1004 for rhodium, and reference number 1006 for gold.

As may be seen from FIG. 5, the highest efficiency is to be achieved with ruthenium, at 0.7. However, a coating made of palladium or rhodium, which have better long-term properties, has an efficiency η (−1) of 0.67, which is only worse by 3%. Gold is typically used in synchrotron gratings, but has significantly worse efficiency than the above-mentioned materials at λ=13.5, as may be seen from the curve 1006.

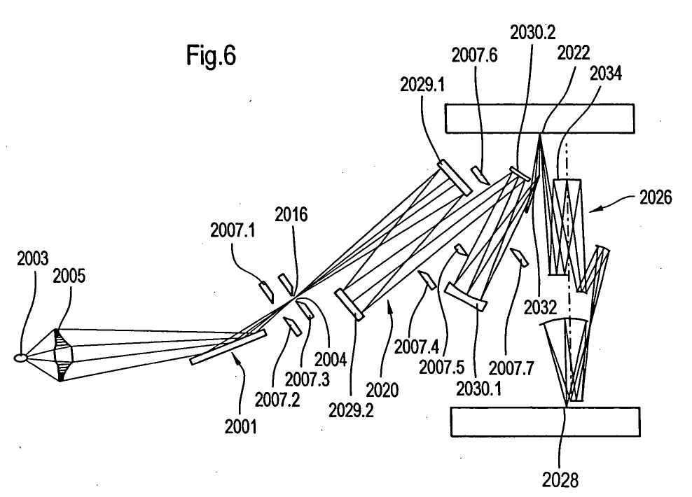

An EUV projection exposure system having a grating apparatus according to the present invention is shown in FIG. 6. All components which are identical to components in the preceding figures have a reference number increased by 2000. The EUV projection exposure facility comprises a light source 2003, and a collecting optical component, e.g., a collector 2005, which is implemented as a nested collector in accordance with German Patent Application DE-A-10102934, filed on Jan. 23, 2001 with the German Patent Office (counterpart of U.S. patent application Publication No. 2003-0043455 A1), the content of which is included in its entirety in the present application. The collector 2005 images the light source 2003 lying in the object plane of the illumination system in an image of the light source or a secondary light source 2004 at a focus 2016 in or near a plane of a physical diaphragm 2007.3.

In the present case, the light source 2003, which may be a laser plasma source or a plasma discharge source, for example, is positioned in the object plane of the illumination system; the image of the primary light source, which is also referred to as the secondary light source, comes to lie in the image plane of the illumination system.

Additional diaphragms 2007.1, 2007.2 are positioned between grating apparatus 2001 and the physical diaphragm 2007.3, in order to block the light of undesired wavelengths, particularly wavelengths greater than 30 nm. According to the present invention, the focus of the −1^{st} order comes to lie in the plane in which physical diaphragm 2007.3 is situated, i.e., the light source 2003 is imaged nearly stigmatically in the plane of the physical diaphragm 2007.3 by the collector and grating spectral filter in the −1^{st} order of diffraction. The imaging in all other orders of diffraction is not stigmatic.

Furthermore, the illumination system of the projection system comprises an optical system 2020 for shaping and illuminating the field plane 2022 with an annular field. As a mixing unit for homogeneous illumination of the field, the optical system comprises two faceted mirrors 2029.1, 2029.2, as well as two imaging mirrors 2030.1, 2030.2 and a field-forming grazing-incidence mirror 2032. Additional diaphragms 2007.4, 2007.5, 2007.6, 2007.7 for suppressing stray light are positioned in the optical system 2020.

The first faceted mirror 2029.1, the field faceted mirror, generates multiple secondary light sources in or near the plane of the second faceted mirror 2029.2, the pupil faceted mirror. Since, using the grating apparatus according to the present invention, the intensity distribution in and downstream of the diaphragm plane of the physical diaphragm 2007.3 is homogenized, a largely homogeneous intensity distribution, i.e., homogeneous illumination, is achieved on the facetted mirror 2029.1 (i.e., mirror having field facets). The following imaging optic images the facetted mirror 2029.2 (i.e., mirror having pupil facets) in the exit pupil 2034 of the illumination system, which comes to lie in the entrance pupil of a projection objective 2026. The angles of inclination of the individual facets of the first and second faceted mirrors 2029.1, 2029.2 are laid out in this case so that the images of the individual field facets of the first faceted mirror 2029.1 overlap in the field plane 2022 of the illumination system and thus a largely homogenized illumination of the structure-bearing mask, which comes to lie in the field plane 2022, is made possible. The segment of the annular field is implemented via a field-forming grazing-incidence mirror 2032 which is operated using grazing incidence.

A double-faceted illumination system is disclosed, for example, in U.S. Pat. No. 6,198,793, and imaging and field-forming components are disclosed in PCT/EP/00/07258. The content of the disclosure of these publications is included in its entirety in the present application.

The structure-bearing mask positioned in the field plane 2022, which is also referred to as a reticle, is imaged in the image plane 2028 of the field plane 2022 with the help of the projection objective 2026. The projection objective 2026 is a 6-mirror projection objective, as is disclosed, for example, in U.S. patent application Publication No. 2002-0056815, the content of which is included in its entirety in the present application. The object to be exposed, such as a wafer, is positioned in the image plane 2028.

The present invention specifies an optical element for the first time, with which it is possible to select undesired wavelengths directly after the primary light source, homogenization of the intensity distribution in and behind the diaphragm plane of the physical diaphragm in an illumination system being achieved through an arrangement of multiple individual gratings on a curved support surface, on a continuous polygonal progression, for example. In addition, the manufacturing of the grating apparatus is greatly simplified, since the blaze angle differences on the different gratings are minimized.

### LIST OF REFERENCE NUMBERS

1 grating apparatus
3 light source5 collector
7.1,7.2 partial diaphragms
7.3 physical diaphragm
8 rear cooling device
9.1,9.2,9.3 individual gratings
10.1,10.2 inlet and outlet of the cooling device
16 focus
100,100.1 collimated light bundle and/or partial light bundle originating from the light source
101 grating element
102,102.1 upper edge beam of the light bundle and/or partial light bundle incident from the light source
104,104.1 lower edge beam of the light bundle and/or partial light bundle incident from light source
106,106.1 center beam of the light bundle and/or partial light bundle incident from the light source
107.3 physical diaphragm
109.1,109.2, 109.17, 109.18 individual gratings
111,111.1 normals
113 focus
115 support
200 incident beam
202 beam diffracted in the 0th order
204 beam diffracted in the 1st order
206 beam diffracted in the −1st order
208 beam diffracted in the +2nd order
211 grating normal
1000,1002, 1004,1006 diffraction efficiency η (−1) for different materials
2001 grating apparatus
2003 light source
2004 secondary light source
2005 collector
2007.1, 2007.2 diaphragms
2007.3 physical diaphragm
2007.4, 2007.5, 2007.6, 2007.7 diaphragms
2016 focus
2020 optical system
2022 field plane
2026 projection objective
2028 image plane
2029.1, 2029.2 faceted mirror
2030.1, 2030.2 imaging mirror
2032 field-forming grazing incidence mirror
2034 exit pupil of the illumination system
Z virtual intermediate image focus in the 0th order
α angle of incidence of a beam in relation to the grating normal
φ angle of a beam in relation to the x coordinate axis
ω angle of inclination of an individual grating

1. A grating apparatus for filtering wavelengths ≦100 nm, comprising:
multiple individual grating elements having grating lines,
wherein said individual grating elements are positioned one behind another on a curved support surface in relation to a plane spanned by said grating apparatus in a direction of beams of a light bundle that is incident on said grating apparatus.

2. The grating apparatus of claim 1, wherein said curved support surface is defined by a continuous polygonal progression.

3. The grating apparatus of claim 1,
wherein each of said individual grating elements has a line density (G) of said grating lines, where 400 lines/mm≦G≦2000 lines/mm, and
wherein said line densities (G) of said individual grating elements vary from one another by ΔG, where 40 lines/mm≦ΔG≦200 lines/mm.

4. The grating apparatus of claim 1,
wherein each of said individual grating elements has a portion of said plurality of partial light bundles incident thereon at an angle α, where 65°≦α≦85°, and
wherein said angles α for said individual grating elements vary from one another by Δα, where Δα≦3°.

5. The grating apparatus of claim 1, wherein said individual grating elements each have a flat grating surface.

6. The grating apparatus of claim 1, wherein said individual grating elements each have an aspheric grating surface.

7. The grating apparatus of claim 1, wherein said grating lines are curved.

8. The grating apparatus of claim 1, wherein said light bundle is a convergent light bundle, and the individual grating elements are blaze gratings.

9. The grating apparatus of claim 8,
wherein each of said individual grating elements has a blaze angle ε, where 1.0°≦ε≦1.6°, and
wherein said blaze angles ε of said individual grating elements vary from one another by Δε, where Δε≦0.3°.

10. The grating apparatus of claim 8,
wherein said beam bundle is incident on each of said individual grating elements element, and
wherein said curved support surface has a curvature so that an image plane of said individual grating elements is substantially identical for each part of said convergent light bundle.

11. An illumination system for wavelengths ≦100 nm, comprising:
an object plane;
a field plane;
the grating apparatus of claim 1; and
a physical diaphragm in a diaphragm plane downstream of said grating apparatus in a beam path from said object plane to said field plane.

12. The illumination system of claim 11, wherein said illumination system has a substantially homogeneous intensity distribution in or downstream of said diaphragm plane in said beam path.

13. The illumination system of claim 12, further comprising a faceted mirror positioned downstream of said physical diaphragm in said beam path.

14. A projection exposure system for manufacturing microelectronic components comprising:
the illumination system of claim 11, for illuminating a structure-bearing mask; and
a projection objective for imaging said structure-bearing mask onto a light-sensitive object.

15. A method for manufacturing microelectronic components, comprising using the projection exposure system of claim 14.
